(19) United States
(12) Patent Application Publication
(10) Pub. No.: US 2026/0300973 A1
(43) Pub. Date: Oct. 1, 2026

(54) TRANSACTION SECURITY FOR MULTI-TIER TRANSACTION NETWORKS

(71) Applicant: HSBC SOFTWARE DEVELOPMENT (GUANGDONG) LIMITED, Guangzhou (CN)

(72) Inventors: Siyuan JIN, Guangzhou (CN); Yong XIA, Guangzhou (CN)

(21) Appl. No.: 18/880,548

(22) PCT Filed: Dec. 7, 2022
(86) PCT No.: PCT/CN2022/137317

§ 371 Date: Dec. 31, 2024

(30) Foreign Application Priority Data
Jul. 7, 2022 (CN) 202210803907.6

(51) Int. Cl. G06Q 20/40; G06Q 20/38

(52) U.S. Cl. CPC G06Q 20/401; G06Q 20/389

(57) ABSTRACT

There is described a method of processing a distributed ledger transaction for submission to a distributed ledger system, the method comprising obtaining transaction information for a requested transaction, generating a distributed ledger transaction to implement the requested transaction including substituting identifying information associated with at least one selected transaction participant with a determined virtual identifier for the selected participant in the distributed ledger transaction, and generating mapping information which maps the virtual identifier to the identifying information of the selected participant. The method can enable the security of identity information and user data Mapping Information to be improved, while allowing transactions to be processed e.g. for regulatory purposes. The method may also include generating one or more further distributed ledger transactions involving virtual transaction participants.

### FIELD OF THE INVENTION

The technology relates to the general field of security and privacy in transaction networks.

The present application relates to improving the security of user data in transaction networks. In particular, the application relates to multi-tiered transaction networks.

### BACKGROUND OF THE INVENTION

Many networks rely on distributed ledger technology for recording transactions, such as transactions of cryptocurrency. Often only some nodes within such networks can record transactions, yet other nodes may nonetheless be required to provide transaction services to user nodes. Accordingly, such networks can have tiered structures in which nodes are hierarchically arranged into a number of subnetworks.

Typically, there is a need to analyse and/or perform regulatory checks on transactions, for example by a central control node within the network. Existing approaches require the higher-tier nodes (which are permitted to record transactions to the distributed ledger) to submit details of transactions, including sender and/or recipient identity information, for analysis or regulatory checks. However, when lower-tier nodes wish to submit transactions to the network, they must provide transaction information directly to the permitted, higher-tier nodes, which can compromise the transaction security and privacy. In particular, the current approaches result in leakage of identity information between the lower-tier and higher-tier nodes, resulting in poor data privacy.

### SUMMARY OF THE INVENTION

Aspects of the invention are set out in the independent claims and preferable features are set out in the dependent claims.

There is described herein a computer-implemented method of processing a distributed ledger transaction for submission to a distributed ledger system, comprising:
obtaining transaction information for a requested transaction, the transaction information comprising identifying information associated with a plurality of transaction participants including at least a transaction sender and a transaction receiver;
determining for at least a selected one of the transaction participants, a virtual identifier;
generating a distributed ledger transaction to implement the requested transaction in the distributed ledger system based on the transaction information, the generating step comprising substituting the identifying information associated with the selected transaction participant with the determined virtual identifier in the distributed ledger transaction;
generating mapping information which maps the virtual identifier to the identifying information associated with the selected participant; and
submitting the generated distributed ledger transaction with the virtual identifier to the distributed ledger system for recording in a distributed ledger.

By substituting identifying information of transaction participants with virtual identifiers in a distributed ledger transaction, the transaction can be recorded to the distributed ledger without having to make the identifying information available to the distributed ledger system. Thus, the security of identity information and user data can be improved. In addition, generating mapping information mapping the virtual identifier to the identifying information of the transaction participant can allow the true participants of the submitted transaction to be determined if needs be, e.g. for regulatory purposes.

The method may comprise making the mapping information available to a transaction processing node arranged to process transactions stored in the distributed ledger. This can enable processing of the distributed ledger transaction to be performed without having to provide identifying information of transaction participants to the whole distributed ledger system. The transaction processing node may be arranged to perform analysis, validation and/or regulatory compliance checks on transactions stored in the distributed ledger. The method may further comprise reconstructing the requested transaction, or a plurality of such transactions, at the transaction processing node using the mapping information.

The method may further comprise, at the transaction processing node: obtaining, from the distributed ledger, information of one or more distributed ledger transactions, the information including one or more virtual identifiers used in the transactions; obtaining, from the generated mapping information, one or more mappings for the one or more virtual identifiers, the mappings mapping each virtual identifier to respective identifying information associated with a transaction participant; and processing the one or more transactions based on the mappings. The one or more transactions may include the generated transaction. Processing the one or more transactions may comprise substituting the mapped identifying information for the virtual identifiers.

The method may further comprise, at the transaction processing node, generating an output or alert indicative of a transaction identified as associated with a potential security, fraud or regulatory compliance risk based on the processing of one or more reconstructed transactions.

The method may further comprise transmitting the generated mapping information to the transaction processing node. Additionally or alternatively, the method may comprise storing the mapping information in a mapping database. The transaction processing node may retrieve the mapping information from the database.

The method may further comprise determining a respective virtual identifier for a plurality of, preferably each of, the transaction participants, and using the virtual identifiers in the transaction in place of the identifying information associated with the transaction participants. The transaction participants may include the transaction sender and one or more transaction receivers.

The, or each, virtual identifier may be unique to one or both of: the participant, and the transaction. The method may further comprise determining a different virtual identifier for the same participant for a subsequent transaction. This can reduce the risk of a third party being able to infer the identifying information of the transaction participant(s) based on the transaction and the subsequent transaction.

The, or each, virtual identifier may be randomly generated. The distributed ledger may comprise a blockchain. The identifying information associated with the, or each, participant may comprise a blockchain address. The blockchain address may be based on a cryptographic public key. The, or each, virtual identifier may comprise a virtual blockchain address. However, other forms of user identifier or cryptocurrency owner identifier (e.g. e-wallet identifier) may be used as the identifying information for transaction participants, and other corresponding forms of virtual identifier may similarly be used.

The step of determining virtual identifier(s) may comprise: determining an input virtual identifier corresponding to a sender of the transaction; determining a change virtual identifier for the sender to receive a change output of the transaction; and creating the distributed ledger transaction using the input virtual identifier for an input of the transaction and the change virtual identifier for an output of the transaction. The change virtual identifier may be different from the input virtual identifier.

The method may further comprise generating in the mapping information mappings from the input virtual identifier and change virtual identifier to the identifying information associated with the sender.

The distributed ledger transaction may comprise: one or more transaction inputs, each associated with identifying information relating to a transaction sender, and one or more transaction outputs, each associated with identifying information relating to a transaction receiver. The method may comprise substituting identifying information associated with one or more of the transaction inputs and/or one or more of the transaction outputs with a respective virtual identifier.

One or more virtual identifiers may be used in the generated transaction in place of the identifying information associated with one or more participants to identify owners of one or more transaction inputs and/or outputs. The transaction inputs and/or outputs may comprise distributed ledger tokens, optionally unspent transaction outputs (UTXO).

The transaction information may comprise a transaction value, the generated transaction for transferring the transaction value from a sender to one or more receivers using one or more virtual identifiers in place of sender and/or receiver identifying information. The virtual identifiers may be used to specify owners of input and/or output tokens of the transaction.

The generated distributed ledger transaction may be a first generated transaction, and the method may comprise: determining receiver identifying information for a receiver of the requested transaction; determining an output virtual identifier for a given output of the first generated transaction and using the output virtual identifier to specify a target of the given output; determining a receiver virtual identifier corresponding to the receiver identifying information, the receiver virtual identifier differing from the output virtual identifier; and generating one or more further distributed ledger transactions for transferring an output transaction value or token based on the given output from the output virtual identifier to the receiver virtual identifier. By generating one or more further distributed ledger transactions, the risk that a third party can infer identifying information of a transaction participant (e.g. of a sender who receives change from the transaction) can be further reduced.

The method may further comprise storing in the mapping information a mapping between the receiver virtual identifier and the receiver identifying information. The output virtual identifier may be associated with a virtual transaction participant. The virtual transaction participant may be a virtual entity that does not correspond to a real transaction participant (e.g. a virtual user or other cryptocurrency holding entity), but which is used as an intermediary for transactions between the real transaction participants. Virtual transaction participants are also referred to herein more generally as “virtual entities”. The method may comprise storing in the mapping information a mapping between the output virtual identifier and the identifying information of the virtual transaction participant. The method may comprise creating at least one further distributed ledger transaction using an input virtual identifier mapped in the mapping information to the virtual transaction participant identifying information. The input virtual identifier for the further transaction may be different from the output virtual identifier.

The generating step may comprise one of: generating a single further transaction for transferring the output transaction value or token to the receiver virtual identifier; or generating a chain of further transactions for transferring the output transaction value or token to the receiver virtual identifier via a series of further virtual identifiers. The single further transaction may be for transferring the output transaction value or token to the receiver virtual identifier via one or more virtual identifiers associated with a virtual transaction participant. The further virtual identifiers may be associated with multiple virtual transaction participants.

The method may further comprise storing mappings between virtual addresses and virtual transaction participants in the mapping information.

The method may further comprise, at the transaction processing node, using the first generated transaction and the one or more further generated transactions together with the mapping information to determine identifying information for one or more transaction participants of the requested transaction and/or to reconstruct the requested transaction.

The method may be performed at least in part at a service provider system for providing distributed ledger transaction services to one or more client systems or end users.

There is also described herein a computer-implemented method of analysing transactions in a distributed ledger system, comprising:
retrieving transaction information for one or more distributed ledger transactions from a distributed ledger, the one or more transactions including one or more transaction inputs and/or outputs specified using one or more virtual identifiers;
obtaining mapping information mapping virtual identifiers to identifying information of transaction participants; and
reconstructing at least one source transaction, the reconstructing comprising substituting one or more virtual identifiers in the transaction information with identifying information of transaction participants obtained using the mapping information.

The method may further comprise processing the at least one reconstructed source transaction. The processing may comprise performing analysis, validation and/or regulatory compliance checks on the at least one reconstructed source transaction.

The method may further comprise generating an output or alert indicative of a transaction identified as associated with a potential security, fraud or regulatory compliance risk based on the processing of the at least one reconstructed source transaction.

Obtaining the mapping information may comprise receiving the mapping information from a service provider system for providing distributed ledger transaction services to one or more client systems or end users, and/or retrieving the mapping information from a database.

The transaction participants may comprise a transaction sender and one or more transaction receivers of one or more, preferably each, of the reconstructed source transactions. The one or more distributed ledger transactions may comprise a plurality of distributed ledger transactions. Reconstructing the at least one source transaction may comprise using the plurality of distributed ledger transactions together with the mapping information to determine identifying information for one or more transaction participants of a single source transaction.

Reconstructing the at least one source transaction may comprise: for each distributed ledger transaction, substituting one or more virtual identifiers in the transaction information with identifying information of transaction participants obtained using the mapping information; and reconstructing, based on the substituting, a chain of transactions for transferring an output transaction value of the source transaction from a source transaction sender to a source transaction receiver.

The transaction participants may comprise one or more virtual transaction participants.

There is also described herein a system having means for performing any method as described herein. The system may comprise one or more processors with associated memory.

There is also described herein a computer program, computer program product or non-transient computer readable medium comprising software code adapted, when executed by a data processing system, to perform any method as described herein.

Any system feature as described herein may also be provided as a method feature, and vice versa. As used herein, means plus function features may be expressed alternatively in terms of their corresponding structure.

Any feature in one aspect of the invention may be applied to other aspects of the invention, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE FIGURES

Certain embodiments of the invention will now be described by way of example only, in relation to the Figures, wherein:

FIG. 1a shows a diagram of an example multi-tier transaction network;

FIG. 1b shows a diagram of another example multi-tier transaction network, for example as an operating architecture for a stablecoin cryptocurrency network;

FIG. 2 is a diagram of different transaction types;

FIG. 3 illustrates an example data structure for a stablecoin cryptocurrency;

FIG. 4 shows example data structures for a transaction;

FIG. 5a shows an example operating architecture with dynamic virtual addresses;

FIG. 5b shows another example operating architecture with dynamic virtual addresses;

FIG. 6a shows a diagram of a method for processing a transaction request;

FIGS. 6b and 6c illustrate example transactions; and

FIG. 7 shows a diagram of an example hardware and software implementation of a server.

### DETAILED DESCRIPTION

Cryptography and distributed ledger technology have led to the development of cryptocurrencies. Cryptocurrencies include unregulated cryptocurrencies and regulated cryptocurrencies, such as stablecoin, central bank digital currency, etc. Transactions in cryptocurrency systems typically comprise two parts: 1. Identity information of payees and payers. 2. Specific transaction amount. For a regulated cryptocurrency, there is often a regulatory requirement to both identity customer information and specify the transaction amount for the purposes of “know your customer” (KYC) and anti-money-laundering (AML).

When implementing regulated cryptocurrency systems, a central issuing institution typically issues the cryptocurrency or stablecoin. If other commercial banks want to circulate the stablecoin from the Stablecoin Issuing Institution, they must provide transaction information and identity information to the Stablecoin Issuing Institution to get approval. However, current approaches to regulated cryptocurrency systems result in leakage of user data between banks and the issuing institutions in order to meet regulatory requirements, resulting in poor data privacy.

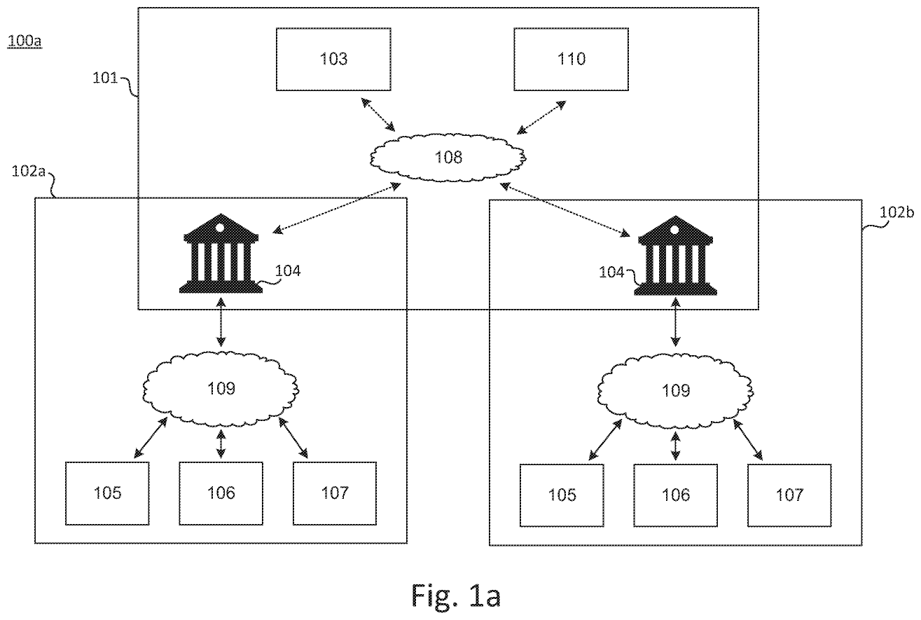

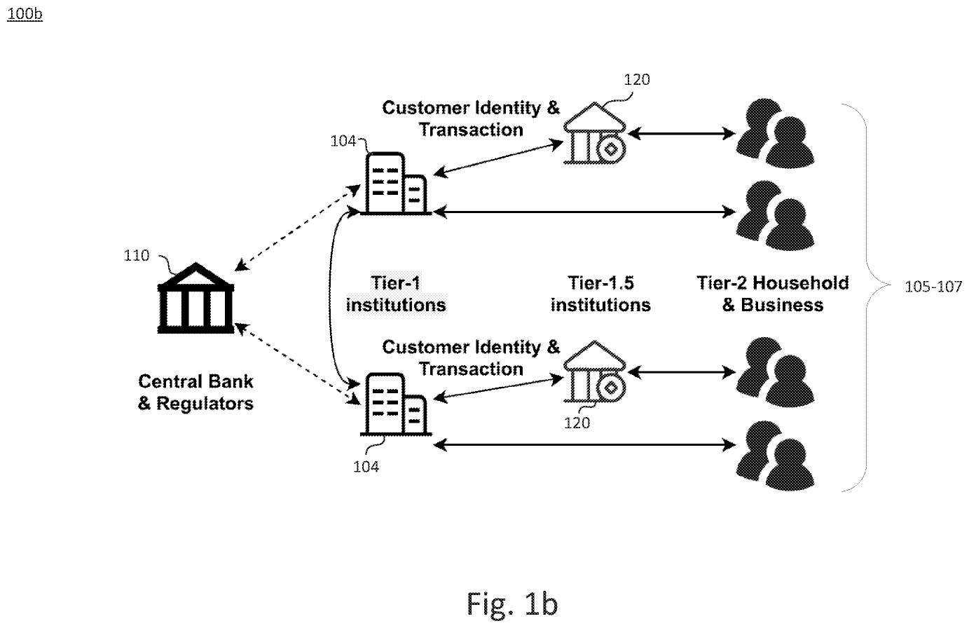

FIGS. 1a-1b illustrate example multi-tiered distributed transaction processing systems 100a, 100b. The term “multi-tiered” preferably refers to an architecture of the system having multiple subnetworks, hierarchically arranged into tiers. The term “operating architecture” or “architecture” preferably refers to a structure that defines the roles of and relationships between entities in a network or system.

In the example embodiments, the multi-tiered systems are systems for processing and recording transactions for transfer of digital tokens, especially value tokens, such as digital currency tokens (e.g. stablecoins). The term “token” preferably refers to any digital representation of value, or of some other asset, that is stored and/or exchanged by the transaction processing system. Such tokens could, for example, include direct data representations of tokens, for example, where a data entity stored in the system uniquely represents a particular asset or quantity of value (e.g. cryptocurrency value). Examples of such tokens could include Unspent Transaction Outputs (UTXO) or similar (e.g. tokens that represent a fixed digital currency quantity), or non-fungible tokens. A “token” may also refer to an abstracted unit of value in an account-based transaction system, for example a cryptocurrency value unit (as for example, in the “Ether” currency of the Ethereum blockchain and Ethereum ERC20 tokens commonly used on Ethereum) where tokens are not directly represented by specific data entities but rather where token ownership is transferred by decreasing/increasing respective user account balances.

Preferably, the system is configured to record one or more transactions, or a block of one or more transactions, to a distributed ledger (e.g. blockchain) or other distributed database. However, the described principles may be applied to other types of blockchain systems and other multi-tiered processing systems.

The system 100a of FIG. 1a has a two-tier architecture, including networks 101, 102a, and 102b for managing the exchange and distribution of tokens, each network including a plurality of nodes (or entities). In some examples, the network 101 can be a wholesale network such as a wholesale central banking digital currency (CBDC) network. The term “central bank digital currency” preferably refers to a digital representative of fiat currency, or a digital currency which is independent of and/or alternative to fiat currency. For example, a central bank digital currency may include regulated digital currency, such as a stablecoin cryptocurrency.

The network 101 includes a control node 110, for example representing/acting for a central bank or token issuing institution, which is communicably connected via a communication network 108 to one or more tier-1 entities 104 (for example representing other banking institutions such as commercial banks). The network 101 handles token transactions between the control node 110 and the one or more tier-1 entities 104. The control node 110 is responsible for designing and issuing the digital currency (e.g. a stablecoin cryptocurrency). The control node 110 is also responsible for settlement between the tier-1 institutions 104.

The network also includes a transaction validation node 103, such as a regulating institution, which is communicably connected via the communication network 108 to the control node 110 and the one or more tier-1 entities 104. As such, the tier-1 entities 104 can directly connect to the control node 110 and the transaction validation node 103. The transaction validation node 103, e.g. a regulatory institution, receives regulatory information from the control node 110 (e.g. representing a stablecoin issuing institution) and tier-1 entities 104 (e.g. representing commercial banks) to validate transaction requests. The term “validation” as used herein preferably refers to the analysis, validation and/or regulatory compliance checks of transactions such as retrospective analysis of a transaction once it has been recorded to the system, e.g. for anti-money-laundering (AML) and/or know your customer (KYC) purposes. This is separate from any technical validation of transactions, e.g. for committing transactions to a distributed ledger such as a blockchain. The node 103 may also be referred to as a validation node, a processing node or a transaction processing node. The system 100a includes at least two tier-2 networks 102a, 102b. In some examples, the system can have only one tier-2 network, or more than two tier-2 networks. One or both of the tier-2 networks 102a, 102b can be a retail network such as a retail CBDC network. Each tier-2 network 102a, 102b includes one of the tier-1 entities 104 communicably connected via a communication network 109 to tier-2 entities 105-107 such as retail clients including individual users, households or businesses or other banks or service providers. The tier-2 network 102a, 102b handles the exchange of tokens between tier-2 entities 105-107 and between tier-2 entities and tier-1 entities 104. In each tier-2 network 102a, 102b, the tier-1 entity 104 may act as a control node for the tier-2 network. Thus, the tier-1 entities 104 may also be referred to as tier-2 control nodes.

In each tier-2 network 102, the tier-1 entities 104 are responsible for interacting with the tier-2 entities 105, 106, 107. As a result, the tier-2 entities 105, 106, 107 can request transactions of cryptocurrency tokens between each other.

The term “tier-1” generally refers to parts of a system with greater privileges and/or responsibilities, such as the authentication or validation of transactions and issuing of cryptocurrency, (e.g. central bank digital currency such as a stablecoin cryptocurrency). These parts of a transaction processing system will generally include and/or interact directly with a global control node, for example representing a central bank, and may be responsible for operating distributed ledgers (e.g. a blockchain) for recording cryptocurrency transactions.

The term “tier-2” generally refers to parts of a system with lower or reduced privileges and/or responsibilities, for example including or interacting directly with clients of the system, such as retail clients including individual users, households or businesses. For example, these parts of the system may not necessarily be permitted to issue currency or authenticate or validate transactions, but may be able to perform other functionalities, such as circulating currency. The terms “tier-1” and “tier-2” are not mutually exclusive, and for example, some entities, such as the tier-1 entities 104 in FIG. 1, can have tier-1 and tier-2 properties.

Some nodes of the system 100a may operate at the boundaries of different tiers. For example, the entities 104 may operate within the tier-1 network 101 and within the tier-2 networks 102a, 102b. Accordingly, they may be referred to as “tier-1 entities”, “tier-2 control nodes” and/or “boundary nodes”.

In some examples, the systems 100a, 100b are associated with a territory, country or jurisdiction. For example, the control node 110, transaction validation node 103, the tier-1 entities 104 and/or the tier-2 entities 105-107 can be located in, operate in or be otherwise associated with the territory, country or jurisdiction. In some examples, the system 100 is a central banking digital currency (CBDC) network operating in a particular country, and the networks 101, 102a, 102b manage the exchange and distribution of digital currency in that country.

In the two-tier CBDC system architecture of FIG. 1a, the tier-1 entities 104 communicate directly with the control node 110 (e.g. representing a central bank) and the transaction validation node 103 (e.g. representing a regulator) and tier-2 entities 105-107 communicate directly with the tier-1 entities 104. The tier-1 entities 104 control the distribution of tokens within the tier-2 networks.

The tier-2 entities 105-107 can communicate with tier-1 entities 104 in order to request that one or more transactions, e.g. CBDC transactions, be recorded to the system. In turn, if the tier-1 entity 104 has sufficient privileges to record transactions to the system, the tier-1 entity records the one or more transactions e.g. to a distributed ledger.

However, not all tier-1 entities or boundary entities (e.g. representing commercial banks) may have the correct privileges or responsibilities to record transactions. Such tier-1 entities having insufficient privileges may be referred to as “tier-1.5 entities”, and as shown in FIG. 1b, tier-1.5 entities 120 may be configured to communicate directly with tier-1 entities 104 that are able to record transactions to the system. Accordingly, the tier-1.5 entities 120 communicate with tier-1 entities 104 (as shown in FIG. 1b) to request that one or more transactions are recorded to the system.

Tier 1.5 entities could, for example, correspond to smaller financial institutions providing payment services for their tier 2 clients, but who have not been given the responsibility to act as tier 1 institutions (typically larger financial institutions) that can directly record cryptocurrency transactions to the distributed ledger in tier-1. Thus, tier-1.5 entities in existing systems have to share transaction data with the tier-1 entities, which may include information that may be used to identify tier-2 entities, such as retail clients including individual users, households or businesses, as well as information about the transactions performed by such clients. This need to share information between tier 1.5 and tier-1 service provider nodes can compromise security.

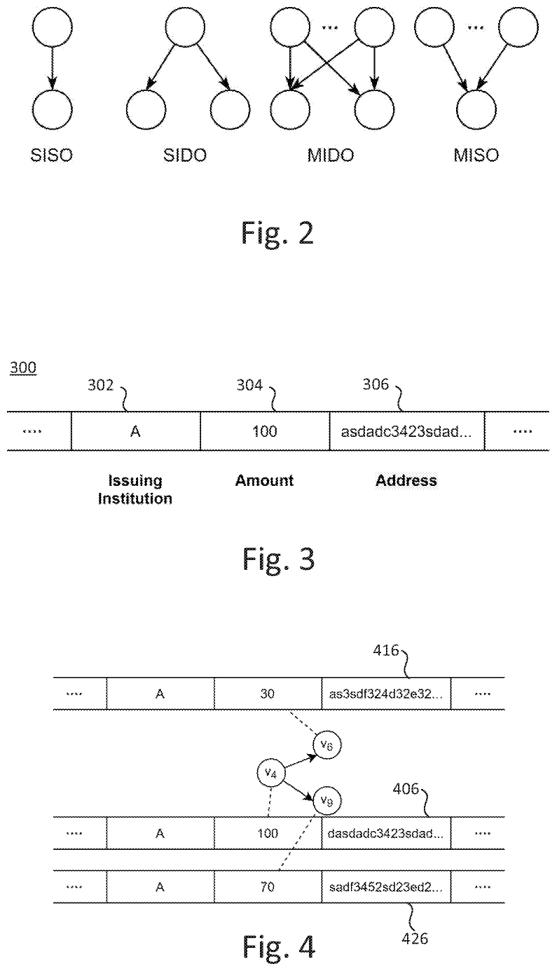

FIG. 2 illustrates potential digital currency transaction types. “SISO” means single-input and single-output transactions; “SIDO” means single-input and double-output transactions; “MIDO” means multiple-input and double-output transactions; “MISO” means multiple-input and single-output transactions. The term “input” preferably refers to the source tokens in a transaction, such as the tokens provided or being offered by one or more users (e.g. payers or senders) for the transaction, while “output” preferably refers to the resulting tokens to be distributed as a result of the transaction, such as the tokens received or expected to be received by one or more recipients (e.g. a payee). For example, in a double-output transaction, one output may be for the tokens received by a recipient (e.g. a payee), while the other output may be for tokens returned to the user who provided the transaction input (e.g. a payer), for example to collect change from the transaction. In a single-output transaction, no change exists. In a multiple-input transaction, the inputs often belong to a single user (e.g. combining tokens of lower value in a single larger-valued transaction). In some examples, the tier-2 entities 105-107 of FIG. 1a/1b may comprise the sender(s) and/or recipient(s) of a transaction.

FIG. 3 depicts an example data structure 300 for digital currency tokens (e.g. stablecoin tokens) which may be used as transaction inputs and/or outputs. The data structure 300 includes information 302 identifying the issuing institution or associated control node 110 (e.g. representing a central bank or digital currency issuing institution), a currency amount 304 and an address 306. For example, the data structure 300 shown in FIG. 3 may be used to represent a transaction input token, in which case the currency amount 304 indicates that 100 units of the digital currency are to be provided as input to the transaction, and the address 306 is an address of the token owner intending to use the token in a transaction (e.g. a payer). The output of a transaction may include one or more tokens of the same structure.

As described in more detail below, embodiments of the invention substitute user addresses with virtual addresses when performing transactions. Thus, the address 306 may be a virtual address assigned by the transaction processing system when creating the token during a transaction, rather than the “real” address associated with the user.

FIG. 4 illustrates a SIDO transaction with associated input and output tokens, represented using the FIG. 3 data structure, where the data structures include dynamic virtual addresses representing the token owners. In FIG. 4, V₄, V₆, V₉ represent different tokens, where V₄ is an input token for the transaction, and V₆ and V₉ are output tokens for the transaction. In this example, a user (e.g. a sender) provides token V₄ as transaction input, and the transaction produces tokens V₆ and V₉ as outputs. The token V₆ is used for returning unspent currency from token V₄ back to the user (e.g. the sender), and token V₉ is used for providing currency to a recipient. The SIDO transaction in this example thus involves a user (the sender) providing 100 units of currency in the form of token V₄, a recipient receiving 70 units of currency in the form of token V₉, and the user (sender) receiving 30 units of unspent currency in return in the form of token V₆.

Accordingly, in the example of FIG. 4, the data structures for Input token V₄ and output token V₆ each include a virtual address 406, 416 for the sender, and the data structure for output token V₉ includes a virtual address 426 for the recipient. In some examples, as shown in FIG. 4, the virtual address 416 for the change output token V₆ can be different from the virtual address of input token V₄. The use of different virtual addresses 406, 416 for tokens belonging to the same user can help protect the user's identity information and make it difficult for entities with access to the distributed ledger (e.g. tier-1 entities) to track transaction flows between users.

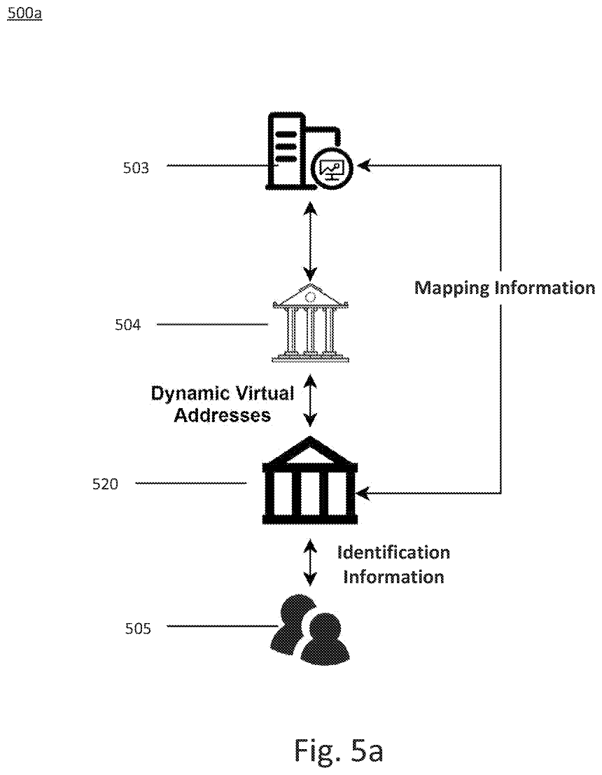

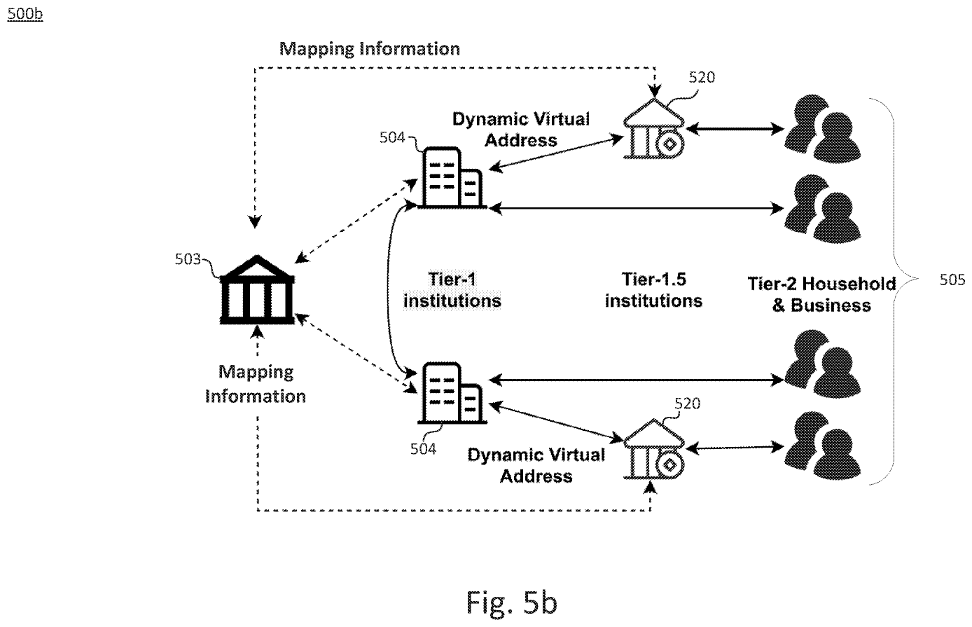

FIGS. 5a and 5b illustrate example multi-tiered transaction processing systems 500a, 500b. In some examples, the system of FIG. 5a may form part of the system of FIG. 5b. In some examples, the system 500a and/or the system 500b may form part of the multi-tiered distributed transaction processing systems 100a, 100b described herein. As shown in FIG. 5a, the system 500a includes a transaction validation node 503 (e.g. the transaction validation node 103 described above), a tier-1 node 504 (e.g. a control node or one of the tier-1 entities 104 described above), a tier-1.5 node 520 (e.g. one of the tier-1.5 nodes 120 described above), and a user node 505 (e.g. one of the tier-2 entities 105-107 described above).

The tier-1.5 node 520 is communicably connected to each of the user node 505, tier-1 node 504 and transaction validation node 503 via one or more communication networks. The tier-1.5 node may be configured to provide transaction services to one or more end users (e.g. individual users, households or businesses) represented by the end user node 505, and accordingly may be referred to as a “service provider node”. The tier-1.5 node 520 is configured to read and write data to a database included at a data store. The data store may be local to the tier-1.5 node 520, or may be provided at one or more servers with which the tier-1.5 node 520 can communicate via a communication network, such as the internet. The data store is used to store mapping information mapping virtual to real addresses as described in more detail below, which can be made available to validation node 503 for validation purposes but is not available to tier-1 node 504.

In addition, the tier-1 node 504 is communicably connected to the transaction validation node 503 via a communication network. The tier-1 node 504 is responsible for recording transactions to the system 500a. For example, the tier-1 node 504 manages a distributed ledger (such as a blockchain). The transaction validation node 503 is responsible for validating transactions. For example, the transaction validation node 503 may be configured to perform regulatory checks based on user/recipient information and transaction amounts, e.g. for the purposes of know your customer (KYC) and anti-money-laundering (AML).

FIG. 5b shows the above approach implemented in a network with multiple tier-2 subnetworks such as that of FIG. 1b, where mapping information from multiple tier-1.5 nodes 520 is supplied to the transaction validation node 503 (e.g. a central bank and/or regulatory institution).

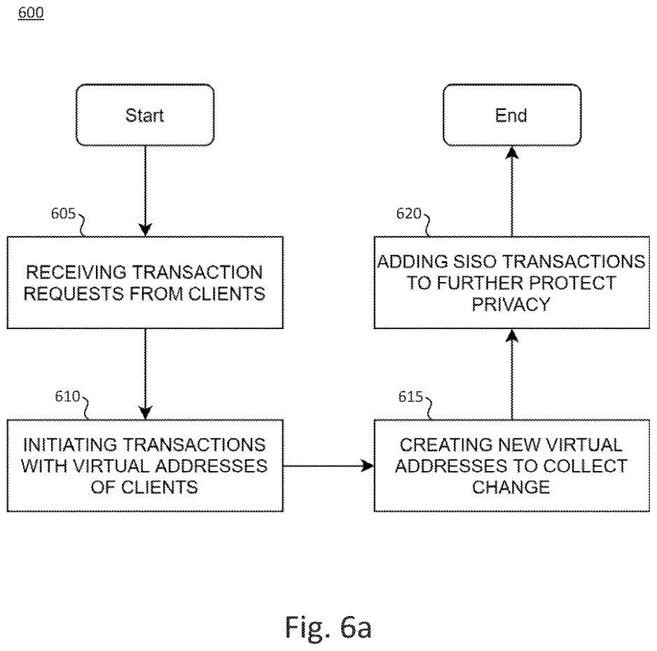

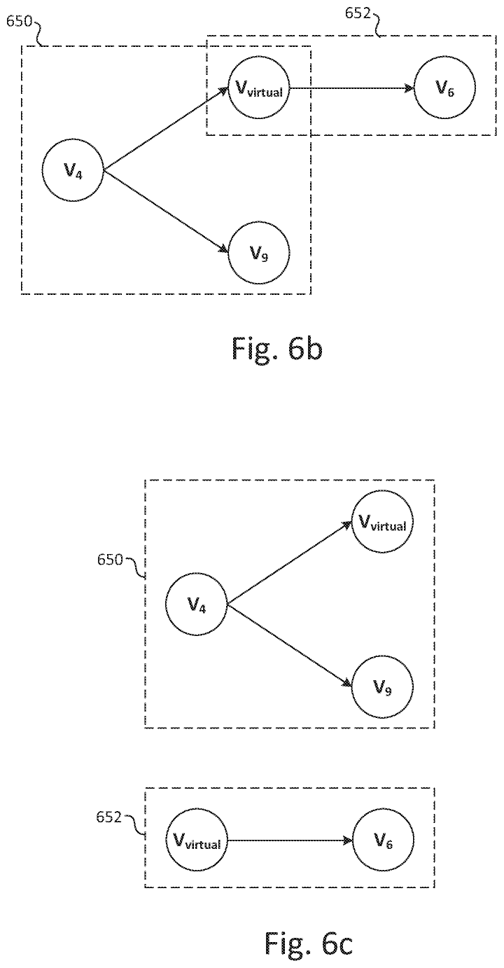

Referring to FIG. 6a, a method 600 for recording a transaction to a distributed transaction processing system will now be described. In the described embodiments, the method 600 is performed using the multi-tiered transaction processing system 500a or 500b described herein, but any suitable multi-tiered system having one or more networks that manage the exchange and distribution of tokens (such as a CBDC transaction processing system) may be used, e.g. the multi-tiered distributed transaction processing system 100a or 100b described herein. In particular, the method 600 may be performed at least in part at a service provider node or system for providing distributed ledger transaction services to one or more client systems or end users. The methods described herein enable one or more transactions (or a block of one or more transactions) of regulated digital currency to be recorded to a distributed ledger, such as a blockchain.

The method 600 begins at step 605 by receiving one or more transaction requests from a user (for example from the user node 505) for recording one or more transactions. The one or more transaction requests are received at a tier-1.5 node (such as tier-1.5 node 520). Each transaction request includes identification information of one or more transaction recipients and a transaction value (e.g. an amount of currency). A transaction request may also include identification information of the user (e.g. the sender). Alternatively, in some examples the transaction request does not include identification information of the user, and the tier-1.5 node can already access user identification information from memory or infer user identification information. For example, an end user may log into a transaction portal provided by the tier-1.5 institution (identifying themselves in the process) and then input transaction information including recipient and amount.

The identification information of the user may be indicative of an identity of the user. For example, the identification information can include an address, such as a public key, of the user (e.g. the sender). Similarly, the identification information of the one or more recipients may be indicative of an identity of each recipient. For example, the identification information can include an address, such as a public key, of one or more of the recipients. The transaction value can be indicative of an amount of currency to be transferred from the user (sender) to the one or more recipients.

In some examples, the transaction request specifies one or more tokens (e.g. stablecoin tokens) to use as input for the transaction. The transaction request may include identification information of a tier-1 node, such as the tier-1 node 504, which is configured to record the transaction to the system. For example, the tier-1 node (e.g. tier-1 node 504) may be responsible for issuing a digital currency (e.g. CBDC) and recording exchanges of that currency.

The method 600 proceeds to step 610, wherein the tier-1.5 node initiates the one or more transactions using one or more virtual addresses. In some embodiments, initiating a transaction includes determining, at the tier-1.5 node, a virtual address for the user (e.g. randomly). The virtual address for the user may be referred to as a user virtual address, a sender virtual address, or an input virtual address. Preferably, a virtual address for each recipient is also determined at the tier-1.5 node (e.g. randomly). The virtual address for each recipient may be referred to as a recipient virtual address, or an output virtual address.

In some examples, the virtual addresses are generated (e.g. randomly) at the tier-1.5 node. For example, the sender virtual address and/or the recipient virtual address(es) may be taken from a pool of pre-generated random addresses that were generated by the tier-1.5 node before the transaction request is received at step 605. Alternatively, the sender virtual address and/or the recipient virtual address(es) may be generated on demand by the tier-1.5 node in response to receiving the transaction request. To further protect the secrecy of user and recipient data, the virtual addresses are preferably generated each time a transaction request is received, and such that they are different to previous virtual addresses generated for the same sender and/or recipient. Each virtual address is thus not only unique across the user population but preferably also unique to a specific transaction. Accordingly, the virtual addresses may be referred to as dynamic virtual addresses. This can prevent the control node 510 (or any other third parties) from inferring an identity or other information of the user (sender) and/or recipient based on the generated virtual addresses, since each virtual address is only used once so different transaction tokens belonging to a single user (e.g. sender or recipient) can each use a different virtual address. In particular, it can prevent the control node from inferring identity information by analysing enough transaction requests (e.g. token flows) and real-world events.

Once dynamic virtual addresses have been assigned to a transaction, mapping records are generated, preferably by the tier-1.5 node. The mappings can then be stored in a database at a data store (e.g. a database), preferably by the tier-1.5 node. The data store is communicably connected to the tier-1.5 node. The mapping records include a mapping from the sender virtual address to an actual address of the sender (e.g. a public key) or other identifying information of that user. Preferably, the mapping records also include mappings between the actual addresses (e.g. public keys) or other identifying information of the recipients and the recipient virtual addresses. In some examples, the mapping records are in the form of a mapping table comprising the mappings. The mapping records may also be referred to herein as “mapping information”.

Initiating the one or more transactions at step 610 includes creating a distributed ledger transaction based on the received transaction requests. For example, the tier-1.5 node can create a blockchain transaction corresponding to the transaction requested by the user, using the sender and/or recipient virtual addresses. Preferably, the distributed ledger transaction contains no information that is indicative of an identity of the sender and/or the recipient(s).

In preferable embodiments, data structures of the type described herein and shown in FIGS. 3 and 4 (e.g. data structure 300) are used to represent tokens (e.g. stablecoin tokens) for the distributed ledger transaction.

Additionally, the tier-1.5 node may be configured to generate a change token (e.g. a stablecoin token) to collect change from the transaction, for example in case an amount of cryptocurrency associated with the one or more input tokens (e.g. as specified in the transaction request) is greater than the transaction value. The change token may be generated automatically based on a determination that unspent cryptocurrency from the transaction will need to be returned to the user (e.g. sender or payer). Accordingly, in such situations, the tier-1.5 node assigns a virtual address to the change token at step 615. In the example shown in FIG. 6a, this can include generating a new virtual address for the change token, e.g. which is different to the sender virtual address. This virtual address for the change token may be referred to as a change virtual address, a return virtual address or an output virtual address, and e.g. can be used for collecting unspent currency in the transaction to be returned to the sender. The change virtual address may be generated randomly and is preferably different to the sender virtual address. Where the transaction request is for a SIDO transaction with an output represented by a change token, the mapping record preferably includes a mapping from the change virtual address to an actual address of the sender (e.g. a public key). In such situations, the distributed ledger transaction is thus created by the tier-1.5 node additionally using the change virtual address, for example using a data structure such as that for token V₆ described herein and shown in FIG. 4.

The tier-1.5 node then submits the distributed ledger transaction to the tier-1 node to record the transaction to the system. For example, the tier-1.5 node 520 may send the one or more modified transaction requests to the tier-1 node 504 to record the transaction to the system 500a, 500b. The virtual addresses can ensure that the tier-1 node cannot acquire identity information of the user (e.g. a payer) and recipients (e.g. payees). This can improve the security of identity information, such as actual addresses (e.g. public keys) of the sender and/or recipients, when recording transactions, while enabling the tier-1 node to record the transaction (e.g. in a blockchain) based on the virtual addresses.

The tier-1.5 node also creates the mapping records as discussed above identifying the mappings between dynamic virtual addresses used in a transaction and identifying information (e.g. actual blockchain addresses or user identifiers) of the transaction participants. This mapping information is made available to the transaction validation node to validate the one or more transactions. In some examples, the tier-1.5 node submits the mapping records directly to the transaction validation node. For example, the tier-1.5 node 520 may send the mapping records (e.g. a mapping table) to the transaction validation node 503. In some examples, the tier-1.5 node (e.g. tier-1.5 node 520) simultaneously submits the transaction to the tier-1 node and provides the mapping records to the transaction validation node (e.g. representing a regulating institution or transaction validation node 503). Alternatively, the tier-1.5 node may provide the mapping records to the transaction validation node on-demand, such as in response to receiving a request for particular mapping information, or the whole table, from the transaction validation node.

In other examples, the tier-1.5 node may make the mapping table available by storing it at a storage location which is accessible by the transaction validation node, for example at a server, and the transaction validation node (e.g. transaction validation node 503) may then access the mapping table when needed.

Accordingly, only the transaction validation node (e.g. representing a regulator) and tier-1.5 node (e.g. representing a non-privileged institution) will know the mapping relationship between virtual addresses and real sender/recipient identities. The tier-1.5 node may only inform the transaction validation node of the mapping information without including other elements of the transaction (e.g. the transaction value).

Once the tier-1 node has recorded a transaction, the transaction validation node (e.g. transaction validation node 503) can obtain transaction information for the recorded transaction. This can include reading the distributed ledger to which the transaction has been committed in order to obtain transaction information, such as a transaction value and one or more virtual addresses for the sender and recipient(s) of the transaction. In some examples, the transaction validation node can obtain transaction information from the distributed ledger for multiple transactions at once. In some examples, the transaction validation node obtains data structures (e.g. data structure 300) described herein and shown in FIGS. 3 and 4 representing input and output tokens for the recorded transaction.

In response to obtaining the mapping records from the tier-1.5 node and obtaining the transaction information, the transaction validation node proceeds to validate the transaction based on the mapping records and the transaction information. The transaction validation node can infer all transaction information by combining the mapping records from the tier-1.5 node and transaction information. In particular, the mapping records are used to determine identification information (such as a real address or public key) of the sender and/or recipients of the transaction based on the mapping(s) between the identification information and virtual addresses. For example, the transaction validation node can obtain, from mapping information generated by the tier-1.5 node, mappings between the one or more virtual addresses and respective identifying information associated with a sender and/or recipient of the transaction. The transaction validation node can then process the one or more transactions based on the obtained mappings. In some examples, this can include substituting the mapped identifying information for the virtual identifiers, e.g. to reconstruct the requested transaction(s). This can enable the transaction validation node to identify the sender and/or recipients in order to analyse the recorded transaction, e.g. for the purposes of know your customer (KYC) and anti-money-laundering (AML).

In some examples, the transaction validation node can generate an output or alert which indicates that the transaction is associated with a potential security, fraud or regulatory compliance risk based on the analysis of one or more reconstructed transactions. For example, the output or alert may be generated internally within the institution (e.g. a regulatory institution) represented by the transaction processing node, and/or the output or alert may be provided to one or more other institutions, such as the institution represented by the tier-1.5 node or a regulatory/legal enforcement body.

A further optional measure to improve the security of user data can be, where the transaction would be a SIDO transaction with a change token (belonging to the sender) as an output, to add one or more SISO transactions at step 620. Adding a SISO transaction includes the tier-1.5 node creating a virtual entity in the system-essentially a virtual transaction participant-with a virtual address, and instead of the change token being assigned directly back to the sender, a token with the virtual address of the virtual entity is used as an output of the transaction (e.g. to collect change). Using a virtual address for the virtual entity means that, like transaction senders and recipients, information which could be used to identify the virtual entity can be kept hidden from higher-tier entities, e.g. as represented by a tier-1 node. Then, an additional SISO transaction from the virtual entity to the original sender is created by the tier-1.5 entity in order to return the change of the transaction to the sender. In other words, the tier-1.5 institution may use a virtual entity as a recipient of the transaction (in place of the sender) to avoid any connection between sender and recipient. This can further protect user data in case information about the identity of the sender can be inferred from a SIDO transaction. Specifically, adding an extra SISO transaction can reduce the risk of the tier-1 node being able to infer sender identity information from the transaction received from the tier-1.5 node, or that addresses used for transaction inputs and outputs relate to the same user (sender).

FIGS. 6b-6c show the above approach implemented at a tier-1.5 node (e.g. tier-1.5 node 520) for a SIDO transaction such as that shown in FIG. 4. A SIDO transaction has an input token V₄ and output tokens V₆ and V₉, where V₆ is a change token for returning unspent currency to the sender (the owner of token V₄). However, as shown in FIG. 6b, an output token Vᵥᵢᵣₜᵤₐₗ (belonging to a virtual entity defined by the tier-1.5 node) is used as an output of the SIDO transaction 650 instead of token V₆. A SISO transaction 652 from the virtual entity to the sender is then added, having the token Vᵥᵢᵣₜᵤₐₗ as its input and token V₆ (assigned to the original user/sender who owns token V₄) as its output. Virtual addresses are substituted in the tokens as described previously. Thus, transaction 650 may use a virtual address for output token Vᵥᵢᵣₜᵤₐₗ which is mapped to the virtual entity in the mapping table. Similarly, transaction 652 may use a virtual address for input token Vᵥᵢᵣₜᵤₐₗ which is mapped to the virtual entity in the mapping records. Though the same virtual address could be used, to further obscure the true transaction flow, different virtual addresses mapped to the same virtual entity may be used.

In this implementation, as shown in FIG. 6c, the SIDO transaction 650 and the SISO transaction 652 are considered as separate transactions. Accordingly, the two transactions 650, 652 are submitted to the tier-1 node separately. In some examples, the SISO transaction is submitted to the tier-1 node after the SIDO transaction, e.g. intervening transactions may be submitted in between the transactions 650, 652, and/or the SISO transaction may be submitted at times of lower network traffic.

In some examples, the tier-1.5 node may add multiple SISO transactions to a SIDO transaction to create a chain of SISO transactions. In such cases, the tier-1.5 node may create multiple virtual entities with virtual addresses, for example each additional SISO transaction may have a different virtual entity as recipient/sender.

If one or more virtual entities are created, the mapping records provided to the transaction validation node can include a mapping between the virtual address and the actual address (e.g. a public key) of each virtual entity. This can allow the transaction validation node (e.g. representing a regulatory institution) to use the original generated SIDO transaction and one or more further generated SISO transactions together with the mapping records in order to determine the identification information (such as actual addresses or public keys) of the sender/recipients of the requested transaction and/or reconstruct the original transaction (without virtual entities), e.g. for KYC or AML purposes. The mapping information may flag addresses as representing virtual entities to allow the validation node to merge the sequence of transactions into the original Intended transaction, and thereby obtain the true identities (blockchain addresses) of the senders and recipients.

In the examples described above, the tier-1.5 node can store virtual address records in memory. The virtual address records may form part of the mapping records and indicate, for each transaction participant, the virtual address(es) used when submitting associated transactions to the distributed ledger system, including the virtual address(es) of any virtual entities used. This can enable tokens which all belong to a single sender or recipient (e.g. an end user) but which have different virtual addresses to be associated with that sender or recipient. Thus, when an end user wishes to use their tokens for a new transaction, the tier-1.5 entity can determine which tokens actually belong to the end user using the virtual address records, and can create a corresponding MISO or MIDO transaction accordingly. In some cases, a service provider node may maintain an e-wallet or similar for a user, recording the tokens held by the user. The user may then simply specify a transaction amount for a payment transaction, with the service provider identifying a suitable token(s) to use in the transaction. In that case, the service provider may store the virtual identifiers actually used for tokens in the blockchain in the wallet, to allow the tokens to be identified efficiently and used for subsequent transactions. Thus, the virtual address records stored by the tier-1.5 node can enable the user to use their tokens for subsequent transactions flexibly without needing to know the virtual addresses used for past transactions. This can also avoid having to communicate virtual addresses to their associated users, thus improving the security of the user's identity information by reducing the chance that a communication potentially linking the virtual addresses to the user(s) is intercepted. Instead of storing virtual addresses in an e-wallet (e.g. alongside the original addresses), the e-wallet may only record the original addresses, with the service provider using the mapping records to identify the associated virtual addresses on demand (e.g. when a user wishes to submit a transaction involving a particular token/address).

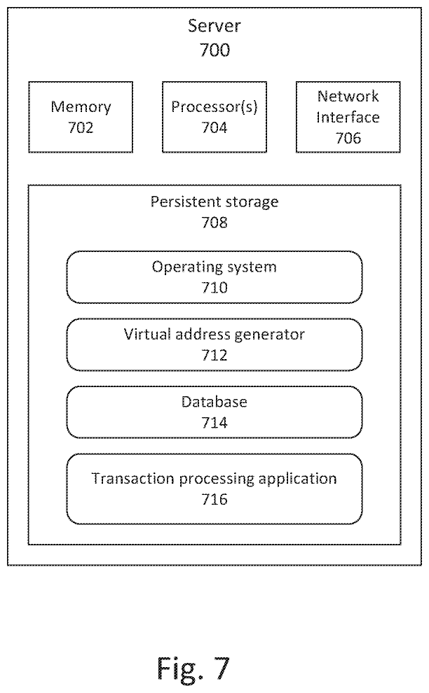

While specific systems 100, 500 and data structures are shown, any appropriate hardware/software architecture may be employed. Example hardware and software implementation of a server is shown in FIG. 7. The depicted server 700 may be used to implement tier-1.5 nodes 120 and 520 of FIGS. 1b and 5a/5b respectively. Server 700 includes a volatile/random access memory 702, one or more processors 704, a network interface 706 and persistent storage 708. The persistent storage 708 contains software and data for implementing the processes and functions described above, including but not limited to an operating system 710, a virtual address generator 712, a database 714 for storing a mapping table, and a transaction processing application 716.

The above embodiments and examples are to be understood as illustrative examples. Further embodiments, aspects or examples are envisaged. It is to be understood that any feature described in relation to any one embodiment, aspect or example may be used alone, or in combination with other features described, and may also be used in combination with one or more features of any other of the embodiments, aspects or examples, or any combination of any other of the embodiments, aspects or examples. Furthermore, equivalents and modifications not described above may also be employed without departing from the scope of the invention, which is defined in the accompanying claims.

1. A computer-implemented method of processing a distributed ledger transaction for submission to a distributed ledger system, comprising:
obtaining transaction information for a requested transaction, the transaction information comprising identifying information associated with a plurality of transaction participants including at least a transaction sender and a transaction receiver;
determining for at least a selected one of the transaction participants, a virtual identifier;
generating a distributed ledger transaction to implement the requested transaction in the distributed ledger system based on the transaction information, the generating step comprising substituting the identifying information associated with the selected transaction participant with the determined virtual identifier in the distributed ledger transaction;
generating mapping information which maps the virtual identifier to the identifying information associated with the selected participant; and
submitting the generated distributed ledger transaction with the virtual identifier to the distributed ledger system for recording in a distributed ledger.

2. A method according to claim 1, comprising making the mapping information available to a transaction processing node arranged to process transactions stored in the distributed ledger.

3. A method according to claim 1, wherein the transaction processing node is arranged to perform analysis, validation and/or regulatory compliance checks on transactions stored in the distributed ledger.

4. A method according to claim 2, comprising reconstructing the requested transaction, or a plurality of such transactions, at the transaction processing node using the mapping information.

5. A method according to claim 2, comprising, at the transaction processing node:
obtaining, from the distributed ledger, information of one or more distributed ledger transactions, optionally including the generated transaction, the information including one or more virtual identifiers used in the transactions;
obtaining, from the generated mapping information, one or more mappings for the one or more virtual identifiers, the mappings mapping each virtual identifier to respective identifying information associated with a transaction participant; and
processing the one or more transactions based on the mappings, optionally comprising substituting the mapped identifying information for the virtual identifiers.

6. A method according to claim 2, comprising, at the transaction processing node, generating an output or alert indicative of a transaction identified as associated with a potential security, fraud or regulatory compliance risk based on the processing of one or more reconstructed transactions.

7. A method according to claim 2, comprising transmitting the generated mapping information to the transaction processing node and/or storing the mapping information in a mapping database, the transaction processing node optionally retrieving the mapping information from the database.

8. A method according to claim 1, comprising determining a respective virtual identifier for a plurality of, preferably each of, the transaction participants, optionally including the transaction sender and one or more transaction receivers, and using the virtual identifiers in the transaction in place of the identifying information associated with the transaction participants.

9. A method according to claim 1, wherein the, or each, virtual identifier is unique to one or both of: the participant, and the transaction.

10. A method according to claim 1, comprising determining a different virtual identifier for the same participant for a subsequent transaction.

11. A method according to claim 1, wherein the, or each, virtual identifier is randomly generated.

12. A method according to claim 1, wherein the distributed ledger comprises a blockchain.

13. A method according to claim 12, wherein identifying information associated with the, or each, participant comprises a blockchain address, based on a cryptographic public key.

14. A method according to claim 12, wherein the, or each, virtual identifier comprises a virtual blockchain address.

15. A method according to claim 1, wherein the step of determining virtual identifier(s) comprises:
determining an input virtual identifier corresponding to a sender of the transaction;
determining a change virtual identifier for the sender to receive a change output of the transaction; and
creating the distributed ledger transaction using the input virtual identifier for an input of the transaction and the change virtual identifier for an output of the transaction, preferably wherein the change virtual identifier is different from the input virtual identifier.

16. A method according to claim 15, comprising generating in the mapping information mappings from the input virtual identifier and change virtual identifier to the identifying information associated with the sender.

17. A method according to claim 1, wherein the distributed ledger transaction comprises: one or more transaction inputs, each associated with identifying information relating to a transaction sender, and one or more transaction outputs, each associated with identifying information relating to a transaction receiver, the method comprising substituting identifying information associated with one or more of the transaction inputs and/or one or more of the transaction outputs with a respective virtual identifier.

18. A method according to claim 17, wherein one or more virtual identifiers are used in the generated transaction in place of the identifying information associated with one or more participants to identify owners of one or more transaction inputs and/or outputs.

19-35. (canceled)

36. A system including one or more processors with associated memory, the one or more processors configured to:
obtain transaction information for a requested transaction, the transaction information comprising identifying information associated with a plurality of transaction participants including at least a transaction sender and a transaction receiver;
determine for at least a selected one of the transaction participants, a virtual identifier;
generate a distributed ledger transaction to implement the requested transaction in the distributed ledger system based on the transaction information, the generating step comprising substituting the identifying information associated with the selected transaction participant with the determined virtual identifier in the distributed ledger transaction;
generate mapping information which maps the virtual identifier to the identifying information associated with the selected participant; and
submit the generated distributed ledger transaction with the virtual identifier to the distributed ledger system for recording in a distributed ledger.

37. A computer non-transitory computer readable medium storing computer interpretable instructions, which when executed by a processor, cause the processor to perform a computer-implemented method of processing a distributed ledger transaction for submission to a distributed ledger system, comprising:
obtaining transaction information for a requested transaction, the transaction information comprising identifying information associated with a plurality of transaction participants including at least a transaction sender and a transaction receiver;
determining for at least a selected one of the transaction participants, a virtual identifier;
generating a distributed ledger transaction to implement the requested transaction in the distributed ledger system based on the transaction information, the generating step comprising substituting the identifying information associated with the selected transaction participant with the determined virtual identifier in the distributed ledger transaction;
generating mapping information which maps the virtual identifier to the identifying information associated with the selected participant; and
submitting the generated distributed ledger transaction with the virtual identifier to the distributed ledger system for recording in a distributed ledger.
